(19) United States
(12) Patent Application Publication
(10) Pub. No.: US 2010/0151836 A1
(43) Pub. Date: Jun. 17, 2010

(54) SYSTEM AND METHOD FOR ACQUIRING MAIL ACCEPTANCE INFORMATION BASED ON VOICE RECOGNITION

(75) Inventors: Kibaek LEE, Daejeon (KR); Dong Gil Na, Daejeon (KR); Hoon Jung, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/637,336

(22) Filed: Dec. 14, 2009

(30) Foreign Application Priority Data
Dec. 15, 2008 (KR) 10-2008-0127349

(51) Int. Cl. H04M 11/10; G10L 15/00

(52) U.S. Cl. 455/413; 704/246

(57) ABSTRACT

Provided is a voice recognition based acceptance information acquiring method and system. The system includes an acquiring module generating voice acceptance information by acquiring acceptance information corresponding to the mail by a user's voice; a converting module for extracting address information corresponding to a destination address of the mail from the voice acceptance information, and converting the extracted address information into voice address information; a matching module for generating computerized acceptance information by matching the voice address information and stored address information; a checking module for checking whether the computerized acceptance information corresponds to the user's voice information; and a receiving module for receiving an acceptance number corresponding to the computerized acceptance information.

### CROSS-REFERENCE TO RELATED APPLICATION

This application claims priority to and the benefit of Korean Patent Application No. 10-2008-0127349 filed in the Korean Intellectual Property Office on Dec. 15, 2008, the entire contents of which are incorporated herein by reference.

### BACKGROUND OF THE INVENTION

(a) Field of the Invention

The present invention relates to a method and system for acquiring mail acceptance information based on voice recognition.

(b) Description of the Related Art

Regarding mail window acceptance, a worker at a window receives written data from a client, inputs the same to a computation system, generates an acceptance number (e.g., registered number) to print it, and attaches it on the mail.

Further, regarding acceptance on the spot, an acceptance worker on the spot takes acceptance information written by a client or the acceptance worker on the spot and picks up the material and acceptance information paper to the mail window in the post office, another worker at the window inputs the information into the system to make it computerized, acquires an acceptance number (e.g., registered number), prints it out, and attaches it to the mail, thereby finishing the acceptance process.

The above-noted acceptance process is inconvenient because the computerized acceptance information is acquired through many tasks such as manual writing, inputting, assigning an acceptance number at the window, outputting a barcode corresponding to acceptance number, and attaching the barcode to the mail.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an acceptance information acquiring method and system based on voice recognition for solving the inconvenience of acquiring predetermined information offline (i.e., the worker at the window faces the client desiring to send mail).

An exemplary embodiment of the present invention provides an acceptance information acquiring system for accepting mail offline, comprising: an acquiring module generating voice acceptance information by acquiring acceptance information corresponding to the mail by a user's voice; a converting module for extracting address information corresponding to a destination address of the mail from the voice acceptance information, and converting the extracted address information into voice address information; a matching module for generating computerized acceptance information by matching the voice address information and pre-stored address information; a checking module for checking whether the computerized acceptance information corresponds to the user's voice information; and a receiving module for receiving an acceptance number corresponding to the computerized acceptance information.

Another embodiment of the present invention provides a acceptance information acquiring method based on user voice when accepting mail offline, including: receiving voice information corresponding to acceptance information from a user, and generating voice acceptance information; extracting voice address information corresponding to a destination address of the mail by reading the voice acceptance information; generating computerized acceptance information by matching the voice address information and predefined address information; receiving an acceptance number corresponding to the computerized acceptance information; and printing the received acceptance number on a barcode.

Yet another embodiment of the present invention provides an acceptance information acquiring method based on a user's voice when accepting mail offline, including: acquiring a provisional acceptance number corresponding to mail to be accepted; receiving voice information corresponding to acceptance information from the user, and generating voice acceptance information; extracting voice address information corresponding to a destination address of the mail by reading the voice acceptance information; generating computerized acceptance information by matching the voice address information and predefined address information; and printing the provisional acceptance number corresponding to the computerized acceptance information on a barcode when the computerized acceptance information corresponds to the user's voice information.

### BRIEF DESCRIPTION OF THE DRAWINGS

FIG. 1 shows a block diagram of an acceptance information acquiring system according to an exemplary embodiment of the present invention.

FIGS. 2A and 2B show a method for connecting an acceptance information acquiring system and an information unit according to a first exemplary embodiment of the present invention.

FIG. 3 shows a method for connecting an acceptance information acquiring system and an information unit according to a second exemplary embodiment of the present invention.

FIG. 4 shows a flowchart of connecting an acceptance information acquiring system and an information unit according to a second exemplary embodiment of the present invention.

FIG. 5 shows a method for connecting an acceptance information acquiring system and an information unit according to a third exemplary embodiment of the present invention.

FIG. 6 shows a flowchart of a connection operation of an acceptance information acquiring system and an information unit according to a third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements

Hereinafter, acceptance information acquiring method and system based on voice recognition according to an exemplary embodiment of the present invention will be described with reference to accompanying drawings.

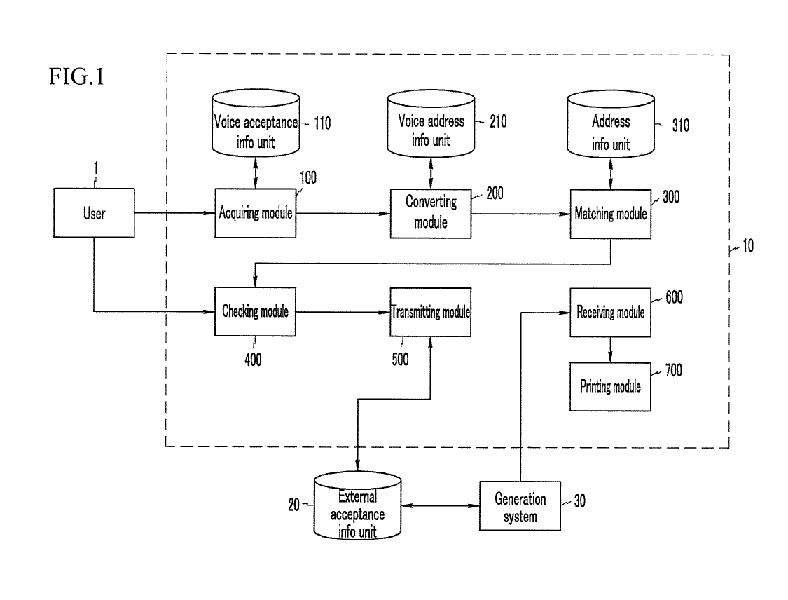

FIG. 1 shows a block diagram of an acceptance information acquiring system according to an exemplary embodiment of the present invention.

When receiving predetermined information on the offline site for acceptance jobs, an acceptance information acquiring system 10 acquires acceptance information by the user's voice and computerizes the same.

As shown in FIG. 1, the acceptance information acquiring system 10 is operable in connection with the user 1, an external acceptance information unit 20, and a generation system 30. The user 1 includes a worker who accepts mail offline and a sender who desires to send mail.

The acceptance information acquiring system 10 is applicable to a mail window, acceptance on the spot, and an unmanned window, and it provides mail information for a mail service or a parcel delivery service, thus playing an important role.

As shown in FIG. 1, the acceptance information acquiring system 10 includes an acquiring module 100, a converting module 200, a matching module 300, a checking module 400, a transmitting module 500, a receiving module 600, and a printing module 700. The acceptance information acquiring system 10 may further include a voice acceptance information unit 110, a voice address information unit 210, and an address information unit 310.

When the user 1 utters acceptance information by voice, the acquiring module 100 acquires voice through a device such as a microphone (not shown) to generate voice acceptance information. For example, voice acceptance information includes a name, a telephone number, and an address of a sender and a name, a telephone number, and an address of a recipient. Also, the acquiring module 100 stores the generated voice acceptance information in the voice acceptance information unit 110 and transmits the same to the converting module 200.

The converting module 200 extracts address information from the voice acceptance information, searches the extracted address information from the voice address information unit 210, and converts the same into voice address information.

The voice address information unit 210 stores voice address information corresponding to the address information extracted from the voice acceptance information.

The address information unit 310 stores a plurality of pieces of predefined address information. Here, the predefined address information represents information on all addresses that are stored to accurately indicate voice address information.

The matching module 300 searches address information of the address information unit 310 by using the converted voice address information to find corresponding address information and matches the converted voice address information and the searched predefined address information to computerize them.

The voice acceptance information unit 110, the voice address information unit 210, and the address information unit 310 have been illustrated to be included in the acceptance information acquiring system 10, but they are not restricted hereto.

The checking module 400 performs a user's confirm process by displaying a matching result value of the matching module 300 that is computerized acceptance information to the user 1. In detail, the checking module 400 displays computerized acceptance information to the user 1 to check whether the acceptance information provided by the user 1 in voice is correctly input, and provides a user interface for correcting a wrong input.

The transmitting module 500 transmits computerized acceptance information to the external acceptance information unit 20 after the user checks through the checking module 400.

The receiving module 600 receives an acceptance number corresponding to computerized acceptance information from the external generation system 30, and transmits the acceptance number to the printing module 700.

The printing module 700 prints the acceptance number as a barcode by using a connected printer (not shown) or a built-in printer (not shown).

The user attaches the printed barcode typed acceptance number to the mail to finish the acceptance task.

The acceptance information acquiring system 10 is illustrated to include the voice acceptance information unit 110, the voice address information unit 210, and the address information unit 310, but the embodiment is not restricted thereto.

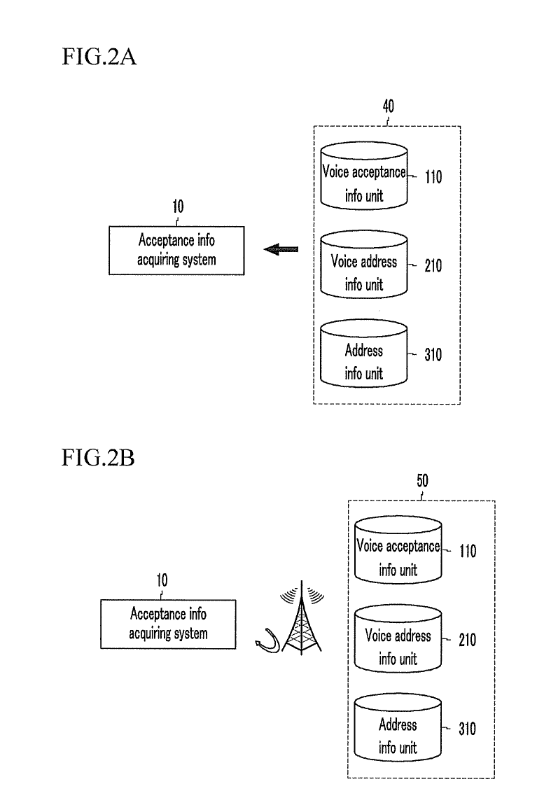

A method for connecting the acceptance information acquiring system 10, the voice acceptance information unit 110, the voice address information unit 210, and the address information unit 310 will now be described with reference to FIGS. 2A and 2B.

FIGS. 2A and 2B show a method for connecting an acceptance information acquiring system and an information unit according to a first exemplary embodiment of the present invention.

As shown in FIG. 2A, the voice acceptance information unit 110, the voice address information unit 210, and the address information unit 310 are installed in the acceptance information acquiring system 10, that is, a mobile device 40, and they are operable in connection with the acceptance information acquiring system 10.

As shown in FIG. 2B, the voice acceptance information unit 110, the voice address information unit 210, and the address information unit 310 are installed not inside the acceptance information acquiring system 10 but in the wireless transmitting/receiving module 50, and they are operable in real-time in connection with the acceptance information acquiring system 10.

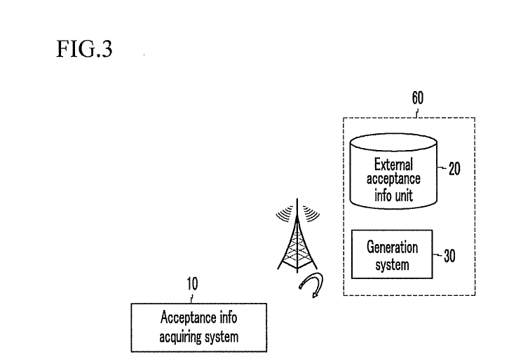

A method for connecting the acceptance information acquiring system 10, the external acceptance information unit 20, and the generation system 30 will now be described with reference to FIG. 3 to FIG. 6.

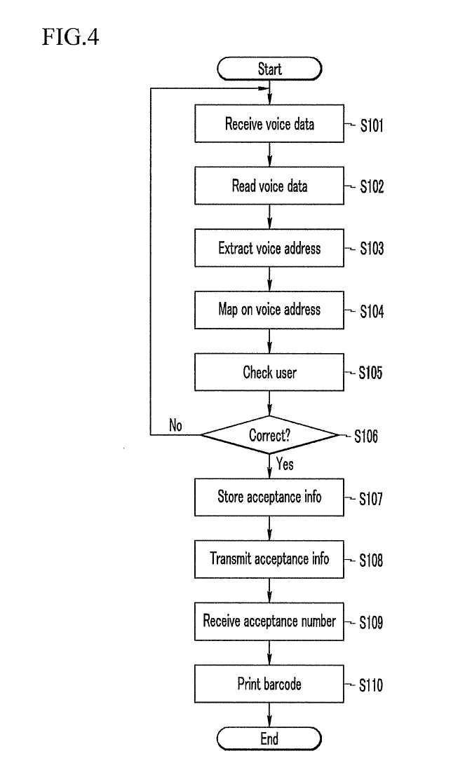

FIG. 3 shows a method for connecting an acceptance information acquiring system and an external acceptance information unit 20 according to a second exemplary embodiment of the present invention, and FIG. 4 shows a flowchart of connecting an acceptance information acquiring system and an external acceptance information unit 20 according to a second exemplary embodiment of the present invention.

As shown in FIG. 3, the acceptance information acquiring system 10 is operable in connection with the wireless transmitting/receiving module 60 including the external acceptance information unit 20 and the generation system 30 so as to transmit the computerized acceptance information and receive the acceptance number.

In detail, the acceptance information acquiring system 10 receives voice corresponding to acceptance information from the user (S101), generates voice acceptance information, and stores the same.

The acceptance information acquiring system 10 reads the generated voice acceptance information (S102) to extract information corresponding to the address from the voice acceptance information, and converts information corresponding to the extracted address into voice address information (S103). Here, the extracted address from voice acceptance information includes an address of a recipient (a destination address) and may further include an address of a sender (an origin address).

The acceptance information acquiring system 10 matches the voice address information and predefined address information to computerize them (S104).

The acceptance information acquiring system 10 displays the computerized acceptance information to the user 1 so that the user may check it (S105), and determines whether to correct the computerized acceptance information based on the user's checking (S106). In detail, when the computerized acceptance information does not correspond to the voice input by the user, the acceptance information acquiring system 10 receives acceptance information from the user again by voice.

On the contrary, when computerized acceptance information corresponds to the voice input by the user, the acceptance information acquiring system 10 stores the computerized acceptance information in the external acceptance information unit 20 (S107). Also, after storing the acceptance information, the acceptance information acquiring system 10 transmits the computerized acceptance information to the wireless transmitting/receiving module 60 (S108), and wirelessly receives an acceptance number corresponding to the transmitted acceptance information from the generation system 30 (S109).

The acceptance information acquiring system 10 prints the barcode including information of the acceptance number and the user may attach the printed barcode to the mail (S110). Upon using the printed barcode, the user can acquire acceptance information without a plurality of jobs including manual writing, inputting, assigning an acceptance number at the window, and outputting and attaching a barcode corresponding to the acceptance number to the mail, and he can perform the acceptance process based on voice corresponding to the acquired acceptance information.

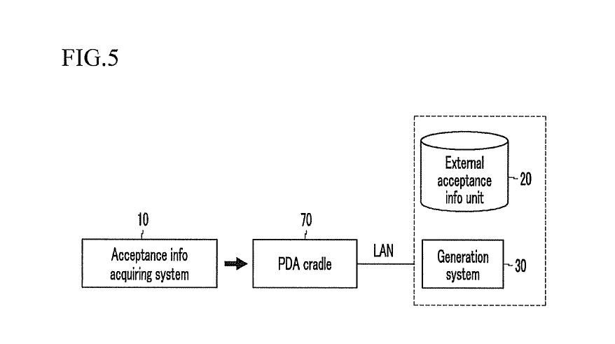

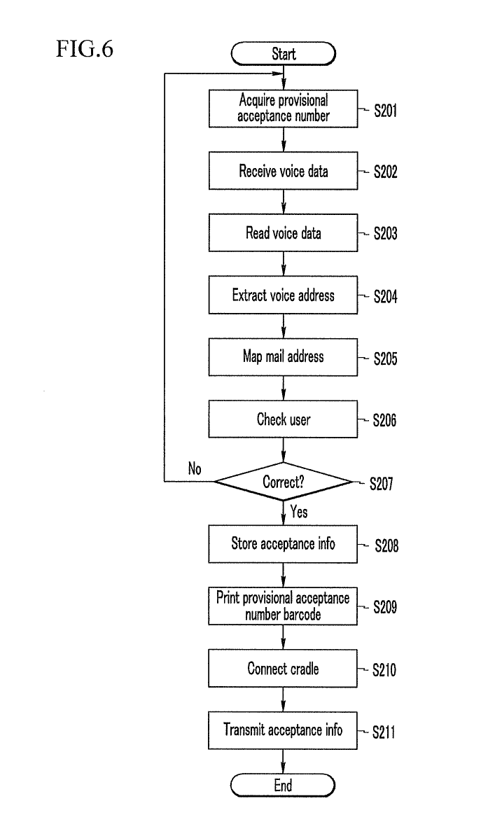

FIG. 5 shows a method for connecting an acceptance information acquiring system and an information unit according to a third exemplary embodiment of the present invention, and FIG. 6 shows a flowchart of a connection operation of an acceptance information acquiring system and an information unit according to a third exemplary embodiment of the present invention.

The acceptance information acquiring system 10 receives a provisional acceptance number before the user's visit on the spot, and immediately assigns an acceptance number corresponding to the provisional acceptance number on the spot. In this instance, the user can access a predetermined server through the Internet corresponding to the acceptance information acquiring system 10 and receive a provisional acceptance number. The user is identified by a user ID or a residence code.

Further, the acceptance information acquiring system 10 can be a portable terminal, but it is not restricted thereto.

The user having finished gathering mail offline and having arrived at the mail window installs the acceptance information acquiring system 10 in the PDA cradle 70, and transmits computerized acceptance information to the external acceptance information unit 20 through the local area network (LAN).

The acceptance information acquiring system 10 represents cable communication using the PDA cradle 70, and it acquires a provisional acceptance number from the generation system 30 (S201). Here, the provisional acceptance number is generated by the generation system 30 before the user visits the spot for acceptance, and it is an acceptance number assigned to the collection target by the user. The provisional acceptance number is allocated per user ID or residence code before the user visits the spot.

When the user visits the spot, the acceptance information acquiring system 10 receives voice corresponding to acceptance information from the user (S202), and generates and stores voice acceptance information.

The acceptance information acquiring system 10 reads the generated voice acceptance information (S203), extracts information corresponding to an address from the voice acceptance information (S204), and converts the information corresponding to the extracted address into voice address information.

The acceptance information acquiring system 10 matches the voice address information and the predefined address information to computerize them (S205).

The acceptance information acquiring system 10 displays the computerized acceptance information to the user 1 so that the user checks it (S206), and determines whether to correct the computerized acceptance information based on the user's checking (S207). In detail, when the computerized acceptance information does not correspond to the voice input by the user, the acceptance information acquiring system 10 receives acceptance information from the user again by voice.

On the contrary, when the computerized acceptance information corresponds to the voice input by the user, the acceptance information acquiring system 10 stores the computerized acceptance information (S208).

After storing the acceptance information, the acceptance information acquiring system 10 prints the provisional acceptance number acquired by the user corresponding to the computerized acceptance information, that is, the provisional acceptance number provided by the generation system 30, on the barcode, and transmits the same to the user so that he may attach the printed barcode to the mail (S209).

The acceptance information acquiring system 10 accesses the external acceptance information unit 20 through the PDA cradle 70 (S210), and transmits computerized acceptance information to the external acceptance information unit 20 by using the connected PDA cradle 70.

According to the embodiment of the present invention, the offline acceptance task becomes simplified so that the acceptance task is finished by facing the client once. In addition, in the case of accepting predetermined information, the process for accepting and receiving acceptance information through the user's voice becomes easier and the acceptance time is reduced.

The acceptance information acquiring system according to the third exemplary embodiment of the present invention receives a provisional acceptance number before the user visits the spot, and it assigns the acceptance number to him on the spot. Also, when the user arrives at the mail accepting window, he sends the entire acceptance information through the PDA cradle, thereby improving convenience of acceptance information input and reducing acceptance time.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An acceptance information acquiring system for accepting mail offline, comprising:
an acquiring module generating voice acceptance information by acquiring acceptance information corresponding to the mail by a user's voice;
a converting module for extracting address information corresponding to a destination address of the mail from the voice acceptance information, and converting the extracted address information into voice address information;
a matching module for generating computerized acceptance information by matching the voice address information and pre-stored address information;
a checking module for checking whether the computerized acceptance information corresponds to the user's voice information; and
a receiving module for receiving an acceptance number corresponding to the computerized acceptance information.

2. The acceptance information acquiring system of claim 1, wherein the voice acceptance information includes a name, a telephone number, and an address of a mail sender, and a name, a telephone number, and address information of a recipient.

3. The acceptance information acquiring system of claim 1, wherein the converting module further extracts address information corresponding to an origin address of the mail from the voice acceptance information.

4. The acceptance information acquiring system of claim 1, further including:
a voice acceptance information unit for storing the voice acceptance information;
a voice address information unit for storing voice address information corresponding to address information extracted from the voice acceptance information; and
an address information unit including the pre-stored address information.

5. The acceptance information acquiring system of claim 1, further including
a printing module for printing the received acceptance number as a barcode.

6. The acceptance information acquiring system of claim 1, wherein
the checking module controls acceptance information to be acquired from the user again when the computerized acceptance information does not correspond to the user's voice information.

7. The acceptance information acquiring system of claim 1, wherein
the acceptance number is generated by an external generation system, the computerized acceptance information is generated by an external acceptance information unit, and the acceptance information acquiring system is operable in connection with the generation system and the acceptance information unit.

8. The acceptance information acquiring system of claim 7, wherein
the generation system and the acceptance information unit are connected wirelessly and in real-time, or are connected through a cradle in a wired manner.

9. An acceptance information acquiring method based on user voice when accepting mail offline, comprising:
receiving voice information corresponding to acceptance information from a user, and generating voice acceptance information;
extracting voice address information corresponding to a destination address of the mail by reading the voice acceptance information;
generating computerized acceptance information by matching the voice address information and predefined address information;
receiving an acceptance number corresponding to the computerized acceptance information; and
printing the received acceptance number on a barcode.

10. The acceptance information acquiring method of claim 9, wherein
the generating of computerized acceptance information includes:
checking whether the computerized acceptance information corresponds to the user's voice information; and
receiving voice information corresponding to acceptance information from the user again when the computerized acceptance information does not correspond to the user's voice information.

11. The acceptance information acquiring method of claim 9, wherein
the generating of computerized acceptance information includes
wirelessly transmitting the computerized acceptance information to an external acceptance information unit.

12. An acceptance information acquiring method based on user's voice information when accepting mail offline, comprising:
acquiring a provisional acceptance number corresponding to mail to be accepted;
receiving voice information corresponding to acceptance information from the user, and generating voice acceptance information;
extracting voice address information corresponding to a destination address of the mail by reading the voice acceptance information;
generating computerized acceptance information by matching the voice address information and predefined address information; and
printing the provisional acceptance number corresponding to the computerized acceptance information on a barcode when the computerized acceptance information corresponds to the user's voice information.

13. The acceptance information acquiring method of claim 12, wherein
the provisional acceptance number is generated before the user visits the spot for having the mail accepted, and it is a temporary acceptance number corresponding to the target to be accepted.

14. The acceptance information acquiring method of claim 12, wherein
the voice acceptance information includes a name and a telephone number of a sender who will send the target to be accepted, and a name and a telephone number of a recipient.
